(19) United States
(12) Patent Application Publication
(10) Pub. No.: US 2014/0132447 A1
(43) Pub. Date: May 15, 2014

(54) Offline Ephemeris Prediction

(71) Applicants: Eric Derbez, Van Couver (CA); Alexander Brown, Vancouver (CA)

(72) Inventors: Eric Derbez, Van Couver (CA); Alexander Brown, Vancouver (CA)

(73) Assignee: Sorce4 LLC

(21) Appl. No.: 13/984,942

(22) PCT Filed: Feb. 29, 2012
(86) PCT No.: PCT/US12/27123

§ 371 Date: Nov. 18, 2013

Related U.S. Application Data
(60) Provisional application No. 61/451,601, filed on Mar. 11, 2011.

(51) Int. Cl. G01S 19/27

(52) U.S. Cl. CPC G01S 19/27
USPC 342/357.66

(57) ABSTRACT

A method is disclosed for autonomously predicting satellite positions for the GPS and other satellite systems using the limited data processing capabilities of a typical embedded user device. The method involves a faster approach for performing initial element adjustments given previous position data. These adjusted initial elements are then used in the prediction calculations. The method may alternatively be used to obtain a fit to a precise orbit prediction of a satellite. A method of correcting a satellite orbit prediction is also disclosed.

### CROSS REFERENCE TO RELATED APPLICATIONS

This application claims benefit under 35 U.S.C. 119(e) of U.S. Provisional Patent Application Ser. No. 61/451,601, filed Mar. 11, 2011, and entitled “Offline Ephemeris Prediction” and PCT Application No. PCT/US2012/027123, filed Feb. 29, 2012, entitled “Offline Ephemeris Prediction” which applications are incorporated herein by reference in their entirety.

### FIELD OF INVENTION

The present invention relates to devices and methods for predicting satellite positions using the limited data processing capabilities of a typical embedded client or user device with meager storage and computing resources. The invention relates to predicting satellite positions for the Global Positioning System (GPS) in particular, but also for other Global Navigation Satellite Systems (GNSS), such as Glonass, and other satellite systems.

### BACKGROUND OF INVENTION

In order to perform a satellite position-fix by triangulation using GNSS navigation systems such as Navstar-GPS or Glonass, the location of the satellites involved needs to be known along with the distance from several satellites to the receiver. The former is obtained from orbit models for each satellite (known as ephemeris) while the latter is obtained from individual measurements of the travel time of signals from each satellite to the receiver (known as pseudo-ranges). The orbit model for a satellite can be broadcast by the satellite itself and is known as broadcast ephemeris (BCE). For NavStar-GPS these orbit models are typically valid for 4 hour time periods (and occasionally 6 hours if the control segment decides so). Outside of these time periods, the accuracy of these models degrades so as to be generally unacceptable for navigation purposes.

To calculate position then, a receiver requires the ability to demodulate the broadcast ephemerides along with the ability to acquire and track the ranging signals from the satellites. However, for many present user devices, the signal strength requirement for the former is substantially greater than for the latter. There can be as much as a 10 dBm, or more, gap in the acceptable noise floor between a user device being able to demodulate a broadcast ephemeris and the user device being able to acquire and track the ranging signal from a satellite. Thus, if a receiver already had accurate ephemeris information, it could potentially produce accurate fixes in an environment 10 dBm noisier than one in which the device still had to demodulate the broadcast ephemeris (BCE).

Not only that, but even in cases where it is possible to demodulate ephemeris, the signal structure and data bit-rate for transmitting ephemeris requires a wait time of anywhere between 18 to 30 seconds for GPS (with similar wait times for Glonass). Thus having an accurate ephemeris model at hand can speed up the time to first fix (TTFF) significantly.

Receiver performance can therefore be significantly improved by having accurate ephemeris readily available, and thus forego having to demodulate broadcast ephemeris by the user device. One way of accomplishing this is to employ a network of ground based stations to receive BCE from the satellites, encode it appropriately, and transmit it to the user device over an alternative communications network of some kind. Further still though, the ground based stations may employ a central server with substantial computational capability to perform the complex calculations needed to accurately predict future ephemeris from the BCE (i.e. to predict the satellite orbits further into the future beyond the valid 4-6 hour time period of typical BCE). This information can then be relayed in an alternative format to individual user devices again over an alternative communications network. With this approach, the tasks of demodulating BCE and predicting ephemeris are picked up by other receivers and servers with substantially greater computational capability than the user devices. However, a disadvantage of this approach, is that the user devices need to have hardware for connecting to the alternative communications network and need to be reliably connected to it. Herein, such methods for predicting future ephemeris at fixed servers and transmitting the information to individual user devices is referred to as online ephemeris prediction.

If user devices were capable of performing the same functions as the aforementioned servers, ephemeris prediction could be performed autonomously on the user device. This would be of advantage because no external connection or additional communications would be required.

Unfortunately, the storage and computing capability of many present day user devices, such as those using a System On a Chip (SOC), is inadequate for this. SOCs are fully contained GNSS chips with their own processors, which typically run at clock speeds well below 100 MHz, and which have only a few megabytes of flash storage for code and data.

Orbit modeling and prediction itself is a very well-known art. Much of the major force modeling is well documented (see Satellite Orbits: Models Methods and Applications, Oliver Montenbruck & Eberhard Gill, or Methods of Orbit Determination, P. R. Escobal) and has been known since before the turn of the century. Herein, a distinction is made between “orbit determination” and “orbit prediction”. “Orbit determination” can often refer to a determination of a coarse present orbit via the Kepler elements (c.f. P. R. Escobal). In Oliver Montenbruck & Eberhard Gill, “orbit determination” usually refers to an accurate post-fact or real time determination of a satellite's orbit. “Orbit prediction” however refers to predicting an orbit N days into the future from where its last state was known (i.e. well beyond the valid time frame of typical BCE). The main issues related to performing orbit prediction on embedded devices are deciding what runtime versus accuracy trade-offs to make.

In order to obtain an accurate orbit prediction model of Middle Earth Orbit satellites (such as those comprising NavStar, Glonass, or Galileo navigation systems) where one can ignore atmospheric drag, one would classically solve a 6 dimensional first order differential equation:
1) dx/dt=a(x(t)), where x=(r,v) i.e. position and velocity, and a(x) incorporates the various accelerations due to:
Earth gravity via a spherical harmonic expansion, e.g. JGM3 to degree and order 10
Solar and Lunar perturbation, e.g. via the JPL DE405 (or DE200) ephemerides
Solar pressure via empirical or semi-empirical models
Empirical accelerations taking the general form:

E(a₀+a₁ sin Nₐν+a₂ cos Nₐν)+E(r₀+r₁ sin Nᵣν+r₂ cos Nᵣν)+E(x₀+x₁ sin Nₓν+x₂ cos Nₓν)
Ocean and Solid Earth tides

Where JGM3 is the gravity model recovered by the Joint Grace Model 3 mission (see The Joint Gravity Model 3, Tapley, B., Watkins, M., Ries, J., Davis, G., Eanes, R., Poole, S., Rim, H., Schutz, B., Shum, C., Nerem, R., Lerch, F., Marshall, J. A., Klosko, S. M., Pavlis, N., Williamson, R. Journal of Geophysical Research, Vol. 101, No. B12, p. 28029-28049, 1996).

Where E maps the local coordinate frame into ECI, aᵢ corresponds to along-track corrections, rᵢ corresponds to radial errors, xᵢ corresponds to cross-track errors, ν corresponds to the true anomaly, while N_{(•)} is a natural number between 1 and 4 (c.f. Oliver Montenbruck & Eberhard Gill p. 112). These empirical accelerations can be thought of as a means to capture un/miss-modelled forces.

Note that for optimal accuracy, one must also use one of the IAU Precession and Nutation models together with the appropriate data from bulletins A and B from the IERS. These help transform coordinates from the terrestrial (ITRS) coordinate system to the celestial coordinate system (ICRS) and back. In particular for an accurate mapping one must employ a series of rotations: X_{ccef}=ΠΘN P X_{cci} where

Π accounts for polar wander
Θ accounts for earth rotation
P accounts for earth precession
N accounts for earth nutation

In general, orbit prediction works on the paradigm that if one can produce models and initial elements which fit historical data well (i.e. when integrating backwards), then the same models and initial elements when integrating forward in time are expected to produce roughly as good a prediction as the fit obtained going backwards in time.

However, to now obtain an accurate prediction of future ephemeris (i.e. orbit prediction), merely having good present orbit models is not enough. One also needs continuous tracking data of good quality (e.g. laser ranging) or good definitive orbits to adjust the initial position, velocity and empirical accelerations (as described above) to obtain a good orbit prediction.

Various conceptual techniques for calculating ephemeris autonomously on user devices have been suggested in the art. In particular, it has been possible since before the turn of this century to use sophisticated programs such as MicroCosm™, to run models using the JPL ephemerides, the full JGM3 gravity model, as well as estimates of empirical accelerations on a laptop, using variational methods developed from the Apollo missions.

U.S. Pat. No. 7,612,712 teaches a method for using force models and empirical accelerations to recover a fit to a high accuracy orbit prediction in which the initial elements are computed on a server and then transmitted to a GNSS device which can then integrate out these elements (generally within a couple of minutes). In fact, the processing power and storage of today's laptops make it possible to perform all these calculations with ease if given the right algorithms and inputs.

However, this is not the case for present day embedded devices used for navigation purposes. They lack math co-processors and are therefore slow to compute math (especially trigonometry) intensive routines. Furthermore, flash storage is often at a premium and this often precludes storage of celestial ephemeris data (i.e. JPL DE 405 ephemerides, as for instance mentioned in U.S. Pat. No. 7,839,330) or earth orientation models to map between ICRS and ITRS coordinates.

However, the known approaches for calculating ephemeris in these ways are still too complex and involved for typical present day user devices and are thus impractical for use.

The method disclosed in US published patent application 2009/0237302 takes a subset of the force models used in the aforementioned U.S. Pat. No. 7,612,712 in order to sequentially estimate initial elements using a cumbersome ad hoc state machine. While the initial element adjustment was to be performed on the GPS device, the techniques disclosed were only practical for more powerful “smart phone” class processors (i.e. 200 MHz or faster processors).

There is therefore, a need for developing mathematical procedures for determining ephemeris in a simplified manner such that user devices with limited processing power and storage can perform this task autonomously.

### SUMMARY OF THE INVENTION

The present invention comprises methods for predicting the orbit of a satellite and user devices based on these methods. In the method, the satellite is characterized by initial elements at initial time t₀ and the method steps comprise:
obtaining reference satellite positions at a set of times {tₖ} wherein k is a positive integer from 0 to m, tₘ<tₘ₋₁< . . . <t₀;
interpolating the reference satellite positions to compute reference Chebyshev polynomials;
storing the reference Chebyshev polynomials;
updating the satellite clock bias and drift and storing the updated clock bias and drift;
computing adjusted initial elements at initial time t₀; and
computing predicted Chebyshev ephemerides using the adjusted initial elements.

In particular, the computing of the adjusted initial elements steps is simplified by:
a) obtaining a set of the initial elements comprising an approximate position, velocity, and at least one free parameter at time t₀;
b) performing numerical integration backwards in time of SSV equations to compute matrices Ψ(tₖ) using the position and velocity from the set of initial elements in step a);
c) performing numerical integration backwards in time of a trajectory y(tₖ) using the position, the velocity, and the at least one free parameter from the set of initial elements in step a);
d) comparing the trajectory y(tₖ) to that obtained from the reference Chebyshev polynomials so as to obtain a satellite position error dr(tₖ);
e) computing adjustment vector \hat{x} wherein \hat{x} is the least squares solution at times {tₖ} for the equation:

Ψᵢⱼ(tₖ)\hat{x}ⱼ≅drᵢ(tₖ)

and wherein i is 1, 2, 3 representing the three position axes;
f) adding adjustment vector \hat{x} to the initial elements used in steps b) and c) thereby obtaining partially adjusted initial elements; and
g) repeating steps b) through f) using the partially adjusted initial elements instead of the initial elements from step a) until the computed adjustment vector \hat{x} is less than a minimum desired value.

In step a), it is satisfactory to use an approximation of the initial elements, although using actual values may be preferred. The position and velocity elements may be obtained from the reference Chebyshev polynomials. The at least one free parameter can be a mean value. In a typical embodiment, the set of initial elements may comprise a plurality of free parameters, such as a plurality of empirical accelerations.

Steps b) and c) in the method can be performed either as separate numerical integrations or alternatively as a single numerical integration. A simplification advantage of this method arises because additional elements such as lunar, solar, and empirical accelerations are not used in step b) in the performing of that associated numerical integration.

In one embodiment, the equations of motion for the computing of matrices Ψ(tₖ) in step b) use a 72 dimensional vector. Default values may be used for the other elements in computing the matrices Ψ(tₖ) in step b).

In another embodiment, the method can optionally include computing lunar and solar ephemerides using Chebyshev polynomials in order to provide lunar and solar accelerations in step c).

The method relies on repeating the steps involved in the initial elements adjustment until the computed adjustment vector \hat{x} is less than a satisfactory predetermined percentage of its previous value. That is, the process is iterated by repeating steps b) through f). A satisfactory predetermined percentage may be 5%. Alternatively, the computed adjustment vector \hat{x} can be deemed to be less than the minimum desired value after a predetermined number of repetitions of steps b) through f). In practice in certain embodiments, 2 iterations can suffice.

A device for predicting the orbit of a satellite using the method of the invention comprises a subsystem for obtaining the reference satellite positions, a CPU comprising at least one integrator for performing steps b) and c), and memory. The CPU may comprise either two integrators or a single integrator.

The present invention is particularly suitable for devices with limited processor capability, e.g. a sub-50 Mhz device. It enables the joint estimation of the initial elements (position, velocity, and empirical accelerations) in a much faster and principled way than the prior art. The algorithms involved can decrease CPU requirements by an order of magnitude and yields more consistent results than the previous ad hoc method.

In a related aspect, the method may be applied to obtain a fit to a precise orbit prediction of a satellite. Again, the satellite is characterized by initial elements at initial time t₀, and the method steps are adapted to comprise:
obtaining the precise orbit prediction;
obtaining reference satellite positions from the precise orbit prediction at a set of times {tₖ}
wherein k is an integer from −1 to m, t₋₁<t₀<t₁< . . . <tₘ;
obtaining an initial velocity from the positions in the precise orbit prediction;
updating the satellite clock bias and drift and storing the updated clock bias and drift;
computing adjusted initial elements at initial time t₀; and
computing predicted Chebyshev ephemerides using the adjusted initial elements.

Here, the computing of the adjusted initial elements comprises:
a) obtaining a set of the initial elements comprising an approximate position, velocity, and at least one free parameter at time t₀;
b) performing numerical integration forwards in time of SSV equations to compute matrices Ψ(tₖ) using the position and velocity from the set of initial elements in step a);
c) performing numerical integration forwards in time of a trajectory y(tₖ) using the position, the velocity, and the at least one free parameter from the set of initial elements in step a);
d) comparing the trajectory y(tₖ) to the precise orbit prediction so as to obtain a satellite position error dr(tₖ);
e) computing adjustment vector \hat{x} wherein \hat{x} is the least squares solution at times {tₖ} (k=0, . . . , m) for the equation:

Ψᵢⱼ(tₖ)\hat{x}ⱼ≅drᵢ(tₖ)

and wherein i is 1, 2, 3 representing the three position axes;
f) adding adjustment vector 2 to the initial elements used in steps b) and c) thereby obtaining partially adjusted initial elements; and
g) repeating steps b) through f) using the partially adjusted initial elements instead of the initial elements from step a) until the computed adjustment vector \hat{x} is less than a minimum desired value.

Advantageously, the more complex calculations can be performed on a server prior to forwarding information to a mobile client. Specifically, the method can involve computing the adjusted initial elements on a server, transmitting the adjusted initial elements to a mobile client by a wired or wireless connection, and then computing the predicted Chebyshev ephemerides using the adjusted initial elements on the mobile client.

Also disclosed is a method of correcting a satellite orbit prediction of validity period [t₀, tₑ] which comprises:
at some point tₚ during the validity period, obtaining at least one new reference satellite position,
using data from the new reference satellite position, fitting an error model mₐ of the along-track error to the data from the satellite orbit prediction,
for a time t in [tₚ, tₑ], evaluating the error model mₐ at t, and
subtracting the evaluation from the error model mₐ at time t from the position of the satellite obtained from the satellite orbit prediction to provide a corrected prediction of satellite position.

Optionally, the method can also include corrections relating to radial and cross-track errors and thus additionally comprises:
using data from the new reference satellite position, fitting error models mᵣ and m_{c} of the radial and cross-track errors to the data from the satellite orbit prediction,
for the time t in [tₚ, tₑ], evaluating the error models mₐ and m_{c} at t, and
subtracting the evaluation from the error models mₐ, mᵣ and m_{c} at time t from the position of the satellite obtained from the satellite orbit prediction to provide a corrected prediction of satellite position.

In these methods of correcting a satellite orbit prediction, the along-track error model mₐ can be a quadratic model, and particularly a quadratic and sinusoidal model. The radial and cross-track models m, and can be sinusoidal with quadratic envelopes.

Again advantageously, the more complex calculations can be performed on a server prior to forwarding information to a mobile client. Specifically, the method can involve fitting the error model mₐ, and optionally the error models mᵣ and m_{c} as well, on a server, transmitting these error models to a mobile client by a wired or wireless connection, and evaluating the error models at t and subtracting the evaluation from the position of the satellite obtained from the satellite orbit prediction on the mobile client.

### BRIEF DESCRIPTION OF THE DRAWINGS

FIG. 1a is a flowchart diagram showing the steps involved in providing an orbit prediction according to a preferred method of the invention.

FIG. 1b is a flowchart diagram of the steps involved in performing the initial elements adjustment step 500 in FIG. 1a for one embodiment of the invention.

FIG. 1c is a schematic diagram of a user device of the invention. This Figure also illustrates the hardware associated with the various steps shown in FIG. 1a.

FIGS. 2a, 2b, 2c, and 2d show plots of the along-track error, the radial error, the cross-track error, and the user range error in meters versus time in days (respectively), corresponding to the orbit predictions of the Examples (in which 2 truth ephemerides spaced 24 hours apart and a dual integrator method of the invention were used).

FIGS. 2c, 2f, and 2g show the effects of applying a quadratic along-track correction; FIG. 2c shows the correction being applied on day 5, FIG. 2f shows the effect of the correction on the user range error, and FIG. 2g shows the uncorrected user range error for comparison purposes.

FIGS. 3 and 4 show actual and corrected radial errors respectively for one of the Examples.

FIGS. 5 and 6 show actual and corrected cross-track errors respectively for one of the Examples.

FIGS. 7 and 8 show actual and corrected along-track errors respectively for one of the Examples.

### DETAILED DESCRIPTION

The present invention describes a method and device which employ certain algorithms that enable the accurate orbit prediction of satellites, such as the Medium Earth Orbit Satellites of the Navstar-GPS or Glonass systems, over time periods beyond the valid time period of BCE, with reduced computational requirements. The methods can be extended to other satellites, such as high eccentricity satellites.

### DEFINITIONS

Herein, the following additional definitions have been used:

ICRS refers to the International Celestial Reference System.

ITRS refers to the International Terrestrial Reference System.

WGS 84 refers to the World Geodetic Survey 84 (a terrestrial reference system almost coincident with ITRS). This is the reference datum used by Navstar-GPS.

PZ90 is the reference datum for Glonass.

ECEF stands for an Earth Centered Earth Fixed (typically in the WGS 84 datum) coordinate system.

ECI stands for an Earth Centered Inertial coordinate system.

ICD-200GPS ephemeris is the 15 parameter ephemeris model described in the Navstar-GPS Interface Control Document ICD-GPS-200, revision C released October 1993. It is often referred to as broadcast ephemeris (BCE). It is uploaded by the control segment every 2 hours to the various satellites in the NavStar constellation, and from these, is broadcast to users.

CPU stands for Central Processing Unit.

Initial Elements refers to positions and velocities in the ECI coordinate system at some epoch, together with a set of free parameters.

Free parameters in the context of initial elements (as above) refer to satellite specific traits which affect accelerations. These include for instance solar pressure terms like Cr or the y-bias, or the empirical acceleration coefficient (as discussed in the Background section).

Momentum Dump is the act of firing thrusters on a satellite to alter its orbit.

OEM is an Original Equipment Manufacturer (as opposed to reseller).

URE User Range Error. Is the error in the distance from a satellite, to the ‘user’. When no ‘user’ is specified, it is assumed to be a sampling of ‘users’ on an earth grid which can see the satellite above their horizon (typically the highest URE sorted to the 65^{th} percentile is quoted).

NVRAM refers to Non Volatile Random Access Memory (e.g. flash memory).

TOE or Time Of Ephemeris is a time-tag typically set at the mid-point of the are described by an ephemeris model.

Function Call-back A software term whereby a function is passed a reference or a pointer to another function through its argument list.

Radial, Along-track, and Cross-track directions are unit vectors used to decompose orbit modeling errors by projecting orbits errors onto them; their calculation is described below.

Given a position r and its associated velocity v in a reference frame (such as in WGS 84 ECI), for orbits with small eccentricity (i.e. in which the velocity vector is approximately perpendicular to the position vector), new coordinate directions are defined as:
2) Radial direction

$${x}_{τ} {=}^{def} r / \vert r \vert$$

3) Along-track direction

$${x}_{a} {=}^{def} {r}_{x} {x}_{c} / \vert {r}_{x} {x}_{c} \vert$$

4) Cross-track direction

$${x}_{c} {=}^{def} {r}_{x} v / \vert {r}_{x} v \vert$$

That is, the radius vector to the WGS 84 origin is taken as correct; the along-track vector however, will not quite align with the velocity vector (except at apogee/perigee).

For orbits with a large eccentricity, the above formulation is recast such that the along-track vector aligns by construction with the velocity vector (this time the radial vector will not quite align with the position vector).
5) Radial direction

$${x}_{τ} {=}^{def} {x}_{cx} {x}_{a}$$

6) Along-track direction

$${x}_{a} {=}^{def} v / \vert v \vert$$

7) Cross-track direction

$${x}_{c} {=}^{def} {r}_{x} v / \vert {r}_{x} v \vert$$

Either set of definitions for the along-track or radial directions works for small eccentricity orbits (e.g. GPS/Glonass) for the purposes of the calculations in this invention. However since most GNSS satellites are about 4 earth radii away from the earth's center, the radial components of a satellite position will dominate non-radial errors (see p. 6 GPStrcam: A Low Bandwidth Architecture to Deliver or Autonomously Generate Predicted Ephemeris ION 2008, Savannah Ga. E. Derbez, R. Lee). Typically only about a quarter of the non-radial errors will contribute to the user line-of-sight error in ranging.

Truth data refers to a set of time-tagged positions (for NavStar-GPS time is in GPS time and position is in the WGS 84 datum; for Glonass time is Moscow local time and position is in the PZ90 datum).

SSV refers to state, state-transition, and variational vector and matrices (c. f. Montenbruck & Gill p. 240).

The present invention enables the joint estimation of the initial elements (position, velocity, and empirical accelerations) in a much far faster, principled way than prior art methods. The algorithm employed decreases CPU requirements by an order of magnitude and yields more consistent results. In particular, the inventive method relies on a series of steps which produce a set of linear equations which describe how small perturbations in the initial elements (r, v, p), i.e. position, velocity, and free parameters ‘p’ at time t₀, translate into position changes at other times {tᵢ}. By comparing the errors of a reference trajectory with respect to the initial truth data collected, it is possible to compute a least squares fit to obtain an adjustment vector (Δr, Δv, Δp) (also denoted \hat{x}) to be added to the initial elements (see in particular equation 25 below). Two iterations of this procedure generally will suffice to optimally fit the elements to the truth data.

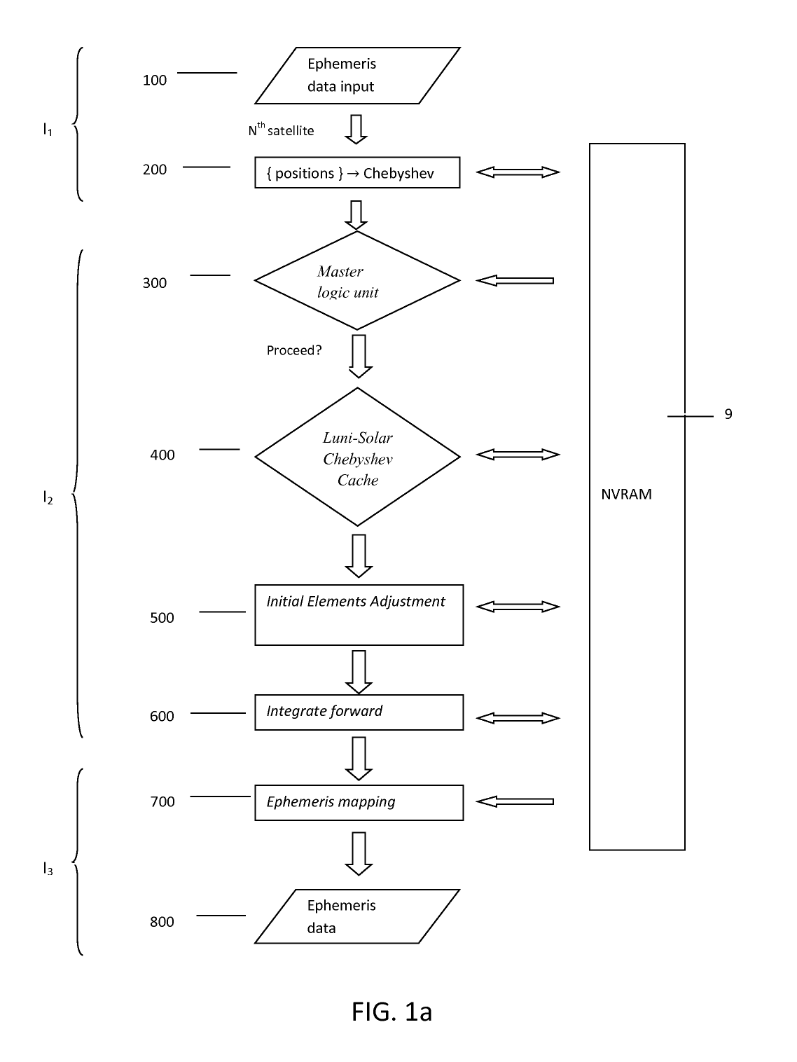

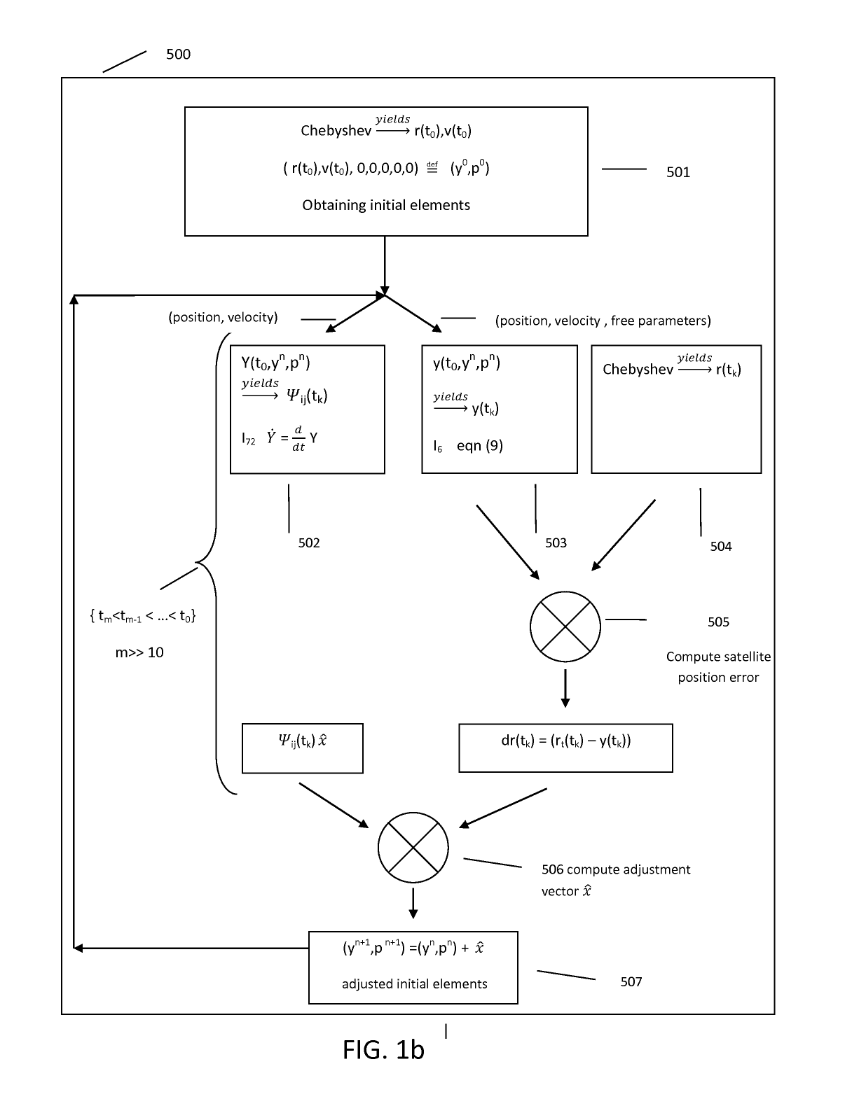

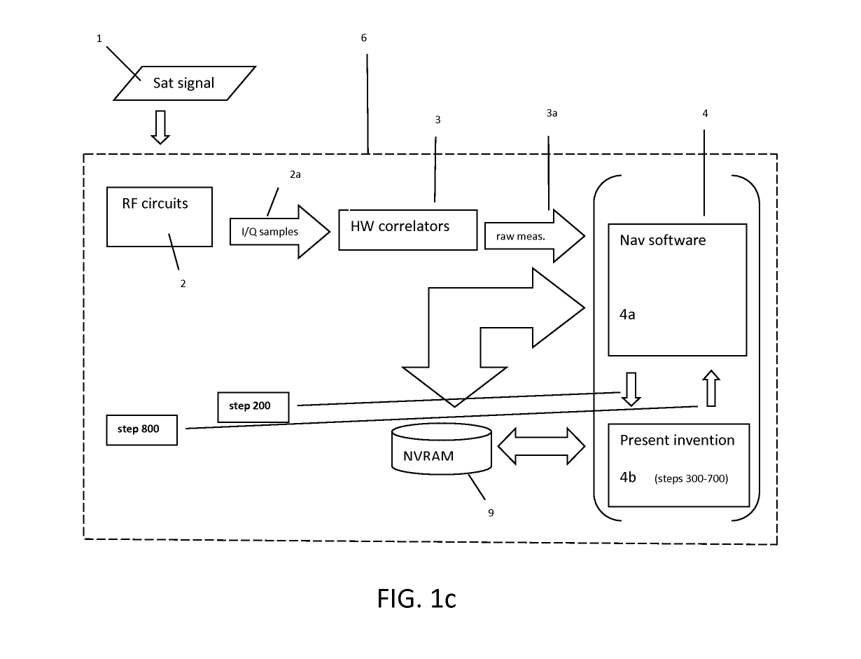

In the method of the invention, an embedded client/GNSS user device is capable of predicting future orbit models from occasionally provided ephemeris data so that frequent demodulation of BCE is not required, and externally provided predicted ephemeris (e.g. from a ground based server) is not required. FIG. 1a shows a flow diagram of the steps involved in predicting ephemeris within the GNSS user device according to a preferred embodiment of the invention. It depicts the steps involved in sequentially processing ephemeris from different satellites. FIG. 1b is a flowchart diagram of the steps involved in the key initial elements adjustment step of FIG. 1a.

As depicted in FIG. 1a, input ephemeris data for satellite N is obtained at step 100 which corresponds to the output of 4a in the apparatus in FIG. 1c (in FIG. 1c, the RF portion of the GNSS device demodulates this ephemeris data). The ephemeris data can be in ICD-200 or Glonass or other suitable format. The input ephemeris data comprises historical reference satellite positions at a set of times {tₖ} wherein k is a positive integer from 0 to m, and the times are thus tₘ<tₘ₋₁< . . . <t₀.

In processing step 200, the series of positions are interpolated and mapped to a Chebyshev polynomial for later use. The preferred method to achieve this is by using the ephemeris calculation routines native to the navigation software of the associated user device (i.e. 4a in FIG. 1c); this avoids unnecessary code duplication between components 4a and 4b in FIG. 1c. Specifically, the code in 4a of FIG. 1c is given a TOE and a function pointer to the ephemeris prediction routine in 4b of FIG. 1c to compute this series of positions.

More specifically in a preferred embodiment, several functions are performed in processing step 200. As mentioned previously, the initial elements are computed from truth data encoded in Chebyshev polynomials. In addition, if previous predicted ephemeris data is available, and its validity intersects that of incoming truth data, then a decomposition of the radial, along and cross-track errors can be performed. A least squares fit can then be performed to fit the radial (mᵣ), along (mₐ), and cross-track (m_{c}) error models below:

mᵣ(t)=(R₁ sin(2πdt)+R₂ cos(2πdt))*dt*dt,

mₐ(t)=A₁+A₂dt+A₃dt*dt+A₃ sin(2πdt)+A₄ cos(2πdt),

m_{c}(t)=(C₁ sin(2πdt)+C₂ cos(2πdt))*dt*dt,

where dt=(t−t₀)/τ, t₀ is initial elements time-tag, and τ is the satellite's period.

The model coefficient (R₁, R₂, A₁, A₂, A₃, A₄, A₅, C₁, C₂) thus obtained are stored for later use in step 700, and the GNSS satellite clock bias and drift are updated. The resulting data in these steps is saved to NVRAM 9.

To be clear, orbit corrections have dimension of length and are applied to the results of numerical integration, whilst empirical accelerations have dimensions of Length/Time² and are used during the numerical integration of the initial elements.

In order for the method to be suitable for use in any GNSS navigation system, the positions (truth data) from ephemeris are mapped into a Chebyshev polynomial in ECI coordinates so as to have a common format regardless of constellation. For GPS, these Chebyshev polynomials will have a 5 hr validity; for Glonass they will have a 1 hr validity. A Chebyshev polynomial will have its degree, reference time (at its center point), and its period of validity. Before storage of this reference data, sanity checks on satellite angular momentum are performed to avoid storing cross-correlated ephemerides (in the case of GPS/Galileo), or frequency re-assignment for Glonass. For GPS, this can be done with just one 5 hour block of data. Finally, the clock bias and drift models for the satellite are updated in processing step 200. Every satellite will have a bias and drift which shall be updated upon reception of another (possibly off-air) ephemeris rather than storing a circular-buffer of previous clocks. For Glonass satellites, (due to their coarse quantization), at least two sets of clock parameters (spread at least a day apart) are needed to determine a clock drift accurate enough for more than a day look-ahead. These are accrued via an exponential filter. Fortunately this is not the case for GPS clock parameters. Their drift rate correction is sufficiently accurate to be used 7 days out (or more).

In greater detail, in processing step 200, a 10^{th} order Chebyshev polynomial able to fit 21 positions from a GPS ICD-200 orbit may be used. This will be stretching the typical usability window of the 4-hour fit to 5 hours, since it is important to obtain observations spanning as close to a half-orbit as possible. It will accumulate the input positions using 21 points spaced at 15 minutes intervals using the basis functions of a Chebyshev polynomial.

The polynomial is the least squares solution to the problem M cᵢ=xᵢ where cᵢ is the 10 dimensional vector of the Chebyshev coefficients for the i^{th} position component (i=1, 2, 3 for x, y, z); xᵢ is the 21 dimensional vector for the i^{th} component (i=1, 2, 3 for x, y, z) of the coordinates of the data to be fit, and M is the 21×10 dimensional design matrix corresponding to the 10 basis vectors evaluated (row-wise) at (−1, −9/10, . . . ,0, . . . , +9/10, +1).

The Chebyshev basis functions can be recovered via the well known Clenshaw recurrence (see Numerical Recipes in C. Flannery, Press, Teukolsky, Vetterling)

The accumulation of the data is done via aᵢ=M^{T} xᵢ i=1, 2, 3, whereas the coefficients cᵢ are recovered via cᵢ=B aᵢ (i=1, 2, 3) where
(8) B=(M^{T}M)⁻¹.

A feature of this method is that by decimating the bits needed to encode the 5 hour Chebyshev block, it is possible to encode 7 days worth of data in 34 (100 byte) Chebyshev blocks.

After processing step 200, computation cycles are now given to processing step 300 in which the data may be probed by a master logic unit for each satellite to determine if a new round of prediction is worth computing. Processing step 300 is an optional step in the overall method. Meta data recording from previous work done in later steps 400, 500 and 600 is read from flash. If a new round of prediction is warranted, the method proceeds to step 400. This is an application specific decision depending on battery-life and accuracy constraints. For instance, an OEM could choose to favor accuracy over battery life and may choose to compute new predictions as often as possible, whereas a different OEM might choose to conserve battery and perform two iterations in step 500 and predict out 7 days, but use orbit corrections up until the end of day 6 before creating a whole new prediction. According to CPU constraints, the module will check each satellite to see if there is enough new truth data to create a new set of initial elements, or whether the computed orbit corrections will keep the prediction accuracy within the user defined tolerance. Depending on other computing tasks to be performed by the CPU, as well as accuracy requirements, the next steps 400, 500, and 600 may be scheduled or skipped altogether.

The next processing step 400 in the sequence pertains to calculating lunar and solar ephemerides for short periods, and caching these. Since flash memory budgets typically preclude the use of JPL ephemerides, trigonometric models must be used to compute luni-solar ephemerides. These trigonometric models are very expensive to compute if the processor cannot perform trigonometric calculations in hardware, thus it is convenient to cache these calculations via Chebyshev polynomials for lunar and solar ephemeris recovery. Lunar and Solar ephemerides may be encoded with 7^{th} and 5^{th} order Chebyshev polynomials (respectively) each spanning 3 days. Thus, these ephemerides will not need to be re-computed when working on different satellites within a common time frame. When computing these polynomials, fixed point math can also be employed to reduce CPU load.

In general, in processing step 400, the time tags of the last round of calculations are read from flash. Then trigonometric models for luni-solar ephemerides are converted into quick-to-compute Chebyshev models whose time span will cover the time span anticipated for steps 500 & 600. These results are then saved to flash.

Processing step 400 uses much the same machinery for parametrizing ephemeris data as in processing step 200 except that the 2 matrices corresponding to B (see equation 8) are of dimension 5×5 and 7×7 for the sun and moon (respectively).

Thus, in processing step 400 (which could be prompted by a timer or triggered by processing step 300), the device will check the latest time-tag of the truth data for all satellites. Then it shall check whether the latest usable luni-solar data is at least N days ahead of this time-tag (N could be 3, 6, or 9 depending on the defaults chosen in processing step 300). If not, it will generate new Chebyshev polynomials for the sun and moon using trigonometric ephemeris models N days past the latest truth data.

In the next processing step 500, the initial elements are adjusted for purposes of future prediction of the satellite orbit. It is in this processing step 500 where the joint estimation of the initial elements (position, velocity, and empirical accelerations) is performed in a much faster, principled way than prior art methods. By reading from flash the “truth” data accrued in processing step 100, initial elements are computed for processing step 600. This will typically take 2 iterations of an algorithm to be described in detail later. Depending on processing step 300, the results are saved to flash or are passed directly to processing step 600.

Processing step 500 employs a series of steps to produce a set of linear equations which describe how small perturbations in the initial elements (r, v, p), i.e. position, velocity, and free parameters ‘p’ at time t₀, translate into position changes at other times {tᵢ}. The errors of a reference trajectory are compared with respect to the initial truth data collected, and a least squares fit is computed to obtain an adjustment vector (Δr, Δv, Δp) to be added to the initial elements. Two iterations of this procedure will suffice to optimally fit the elements to the truth data.

FIG. 1b is a flowchart diagram of the steps involved in performing the initial elements adjustment step 500 in FIG. 1a for one preferred embodiment of the inventive method. In the first processing step 501, a set of initial elements is obtained comprising an approximate position, velocity, and at least one free parameter at initial time t₀. The position and velocity elements can desirably be obtained from the reference Chebyshev polynomials computed previously in processing step 200. Alternatively, the position information may be obtained directly from the satellite positions provided at step 100. And while it is sensible to use the exact values obtained in these ways, for purposes of the method, approximate values will suffice. And while only one free parameter is necessarily involved in the method, it is generally expected that a plurality of free parameters will be involved.

The initial elements are then used in two numerical integrations, depicted in FIG. 1b as processing step 502 and 503 respectively. In processing step 502, only the position and velocity elements are used to perform a numerical integration backwards in time of SSV equations in order to compute matrices Ψ(tₖ). However in processing step 503, all the initial elements are used (generally including numerous free parameters) to perform a numerical integration backwards in time of a trajectory y(tₖ). The former is thus a relatively low-accuracy integration while the latter is a relatively high-accuracy integration.

In the preferred embodiment described in detail here, two different integrators are used for this purpose (as discussed later, in an alternative embodiment, the method can also be accomplished with one integrator). For efficiency's sake, the integrators will both be multi-step. The first will handle the 72 dimension state, state transition, and variational (SSV) equations when determining the initial position velocity and empirical accelerations as described above in processing step 200. The 2″ integrator will perform the numerical integration with just the 6 elements (position and velocity) while applying luni-solar effects (using processing step 400 or directly from the trigonometric models) and the empirical accelerations found by the SSV integration. For convenience, the 72 dimensional integrator will be referred to here as I₇₂ and solve for a vector Y(t), while the 6 dimension integrator will be referred to as I₆ and solve for a vector y(t).

The reference trajectory y(t) comprises the more advanced models, and is the reference against which errors with respect to the truth Chebyshev polynomials are calculated. The reference trajectory's force model a(t, r, p), will take into account the luni-solar accelerations too and actually apply the radial and along-track accelerations in the vector a(t, r, p).

The I₆ solves the differential equation:

$$\frac{d}{d t} y ( t , p ) = f ( t , y ( t , p ) ) = ( v ( t ) , a ( t , p ) ) , \\ y ( {t}_{0} ) = ( r ( {t}_{0} ) , v ( {t}_{0} ) ) \qquad ( 9 )$$

with

$$a ( t , p ) {=}^{def} {a ( t , r )}_{earth gravity} + {a ( t , r )}_{moon} + {a ( t , r )}_{sun} + {a ( t , r , p )}_{emp} + {a ( t , r )}_{solar pressure}$$

in ECI, where
a(t,r)_{earth gravity} uses the JGM3 model to degree and order 3,
a(t,r)ₘₒₒₙ+a(t,r)ₛᵤₙ use the ephemeris models cached in processing step 400,
a(t,r)_{solar pressure} corresponds to solar pressure, and
a(t, r, P)ₑₘₚ is formulated by first constructing the radial and along track unit vectors xₐ and xᵣ as in equations (6) and (5) or (3) and (2) respectively. Letting
(10)θ=2π(t−t₀)/τ, where τ is the satellite's period, and
   (note that the approximation θ≅ν for empirical accelerations mentioned in the Background section is valid for orbits of small eccentricity, e.g. GPS, Glonass, Galileo)
(11) p=(Cᵣ, Sᵣ, Cₐ, Sₐ, A₀) i.e. the 5 dimensional vector of radial and along-track parameters, then
(12) a(t, r, p)ₑₘₚ=xᵣ(Cᵣ cos(2θ)+Sᵣ sin(2θ))+xₐ (Cₐ cos(θ)+Sₐ sin(θ)+

The I₇₂ integrator will help solve equation (18), with the 72 dimensional vector Y(t) (note that if the constant along track acceleration A₀ term were dropped, one could use a 66 dimensional integrator as explained after equation (18)).

Let \tilde{y}(t) be the 6-dimensional vector defined, similarly to the state vector y(t) in equation (9), as the solution of the following simplified state vector differential equation:

$$\begin{matrix} \tilde{y} ( t ) = ( r ( t ) , v ( t ) ) and & ( 13 ) \\ \frac{d}{d t} \tilde{y} ( t ) {=}^{def} f ( t , \tilde{y} ) = ( v ( t ) , \tilde{a} ( t , r , p ) ) , where \tilde{a} ( t , r ) = {a ( t , r )}_{earth gravity} & ( 14 )\end{matrix}$$

i.e. ã(t,r) is the acceleration due to earth's gravity using the GJM3 model to order and degree 3, as well as the partials of the radial and along-track sinusoidal and constant acceleration corrections in equation (12).

Let Φ(t, t₀) be the 6×6 state transition matrix, defined by the following equations:

$$\begin{matrix}Φ ( t , {t}_{0} ) = \frac{\partial \tilde{y} ( t )}{\partial \tilde{y} ( {t}_{0} )} , state transition matrix can be found by solving & ( 15 ) \\ \frac{d}{d t} Φ ( t , {t}_{0} ) {=}^{def} {( \begin{matrix}\frac{\partial v}{\partial r} & \frac{\partial v}{\partial v} \\ \frac{\partial \tilde{a}}{\partial r} & \frac{\partial \tilde{a}}{\partial v}\end{matrix} )}_{6 \times 6} Φ ( t , {t}_{0} ) , where Φ ( {t}_{0} , {t}_{0} ) = {1}_{6 \times 6} , & ( 16 )\end{matrix}$$

Note: ∂ã/∂r=0 for Medium Earth Orbit satellites (no dissipative drag)

The sensitivity matrix S=∂ã/∂p is defined by its time derivative:

$$\frac{d}{d t} S ( t ) {=}^{def} {( \begin{matrix}0 & I \\ \frac{\partial \tilde{a}}{\partial r} & 0\end{matrix} )}_{6 \times 6} S ( t ) + {( \begin{matrix}0 \\ \frac{\partial \tilde{a}}{\partial p}\end{matrix} )}_{6 \times n ( p )} , where S ( {t}_{0} ) = {0}_{6 \times n ( p )} . \qquad ( 17 )$$

Then the problem of solving the SSV coefficients can be cast as:

$$\frac{d}{d t} ( Φ , S ) = {( \begin{matrix}0 & I \\ \frac{\partial \tilde{a}}{\partial r} & 0\end{matrix} )}_{6 \times 6} ( Φ , S ) + {( \begin{matrix}0 & 0 \\ 0 & \frac{\partial \tilde{a}}{\partial p}\end{matrix} )}_{6 \times ( 6 + n ( p ) )} \qquad ( 18 )$$

Here n(p) is the dimension of the empirical accelerations in (9); thus the dimension of Y is 6+6×6+6×(n(p)). Note that the ordered pair (Φ, S) is 6×(6+n(p)) dimensional.

The I₇₂ integrator will use the initial position and velocity derived from the reference Chebyshev polynomials in processing step 200 to start a sequence of iterations of the SSV equations (to be described below) which comprise the partial derivatives for position and velocity, as well as the partial derivatives for the empirical accelerations. Optionally, the partial derivatives for solar pressure can also be added. Note that neither integrator needs to estimate/use parameters for the GPS-UTC offset, nor orientation parameters for nutation or precession to align celestial and terrestrial frames. The estimation of the initial elements is done by finding corrections to the discrepancy between the output of y(t) and the truth data in step 200 via the state transition and sensitivity matrices (Φ, S) in a least squares sense. During the sequence of iterations for the initial elements, the consistency of the fit with respect to the truth positions stored in step 200 will determine whether the satellite modeled there performed a momentum dump (thus introducing forces which cannot be modelled). Additionally, a model for the prediction accuracy versus time is generated for each satellite given the observations available (typically the more observations available, the better the accuracy, but the final fit will determine the accuracy).

The SSV equations for solving Y then are:

using the same definition of p as in equations (11) and a(t, r, p)ₑₘₚ as in (9), one can view Y as the column-wise composition of \tilde{y}ᵢ the solution to (14), and (Φ, S) where:
(19) \tilde{y}ᵢ=Yᵢ i=1, 2, 3 (position)
\tilde{y}ᵢ₊₃=Yᵢ₊₃ i=1, 2, 3 (velocity)
Φ_{i,1}=Y₁₊₆ i=1, . . . , 6 (i.e. the 1st column of Φ)
Φ_{i,2}=Y₁₊₁₂ i=1, . . . , 6 (i.e. the 2nd column of Φ)
Φ_{i,3}=Y₁₊18 i=1, . . . , 6 (i.e. the 3rd column of Φ)
Φ_{i,4}=Y₁₊₂₄ i=1, . . . , 6 (i.e. the 4rd column of Φ)
Φ_{i,5}=Y₁₊₃₀ i=1, . . . , 6 (i.e. the 5rd column of Φ)
Φ_{i,6}=Y₁₊₃₆ i=1, . . . , 6 (i.e. the 6th column of Φ)
S_{i,1}=Y₁₊₄₂ i=1, . . . , 6 (i.e. the 1st column of S)
S_{i,2}=Y₁₊₄₈ i=1, . . . , 6 (i.e. the 2nd column of S)
S_{i,3}=Y₁₊₅₄ i=1, . . . , 6 (i.e. the 3rd column of S)
S_{i,4}=Y₁₊₆₀ i=1, . . . , 6 (i.e. the 4th column of S)
S_{i,5}=Y₁₊₆₆ i=1, . . . , 6 (i.e. the 5th column of S)

Then

$$\dot{Y} = \frac{d}{d t} Y ,$$

can be recovered by first computing (in the ECI frame):

G_{3×3}=∂ã/∂r the partials of earth's acceleration consistent with the order and degree 3 as above, and finally, at point (r,v) computing the radial and along-track unit vectors xₐ and xᵣ as in (6) and (5), and using θ as in (10) we have
∂ã/∂p=(xᵣ cos(2θ), xᵣ sin(2θ), xₐ cos(θ), xₐ sin(θ), xₐ)

Now we can recover the derivative \dot{Y} of Y using equations (14), (16) and (18):
(21) \dot{Y}ᵢ=vᵢ i=1, 2, 3 (velocity)
\dot{Y}ᵢ₊₃=aᵢ i=1, 2, 3 (acceleration)
\dot{Y}ᵢ₊₆=\dot{Φ}_{i,1} i=1, . . . , 6 (the 1st column of \dot{Φ})
\dot{Y}ᵢ₊₁₂=\dot{Φ}_{i,2} i=1, . . . , 6 (the 2nd column of \dot{Φ})
\dot{Y}ᵢ₊₁₈=\dot{Φ}_{i,3} i=1, . . . , 6 (the 3rd column of \dot{Φ})
\dot{Y}ᵢ₊₂₄=\dot{Φ}_{i,4} i=1, . . . , 6 (the 4th column of \dot{Φ})
\dot{Y}ᵢ₊₃₀=\dot{Φ}_{i,5} i=1, . . . , 6 (the 5th column of \dot{Φ})
\dot{Y}ᵢ₊₃₆=\dot{Φ}_{i,6} i=1, . . . , 6 (the 6th column of \dot{Φ})
\dot{Y}ᵢ₊₄₂=\dot{S}_{i,1} i=1, . . . , 6 (the 1st column of \dot{S})
\dot{Y}ᵢ₊₄₈=\dot{S}_{i,2} i=1, . . . , 6 (the 2nd column of \dot{S})
\dot{Y}ᵢ₊₅₄=\dot{S}_{i,3} i=1, . . . , 6 (the 3rd column of \dot{S})
\dot{Y}ᵢ₊₆₀=\dot{S}_{i,4} i=1, . . . , 6 (the 4th column of \dot{S})
\dot{Y}ᵢ₊₆₆=\dot{S}_{i,5} i=1, . . . , 6 (the 5th column of \dot{S})

As per the initial conditions of (16) and (17), the initial 72 dimensional vector is:
(22) Y(t₀)=(r(t₀),v(t₀),1,0,0,0,0,0,0,1,0,0,0,0,0,0,1,0,0,0,0,0,0,1,0,0,0,0,0,0,1,0,0,0,0,0,0,1, . . . ,0)
   (all entries Yᵢ(t₀) for i=43 to 72 are 0).

Thus (19) and (21) with initial conditions (22) define a well-posed ordinary differential equation.

Now that the problem of solving y(t) and Y(t) for the reference and SSV orbits (respectively) have been properly posed, we can describe the adjustment of the initial elements. The matrices Ψ(tₖ) are computed as part of step 502 as shown in FIG. 1b. And, a trajectory is obtained from the reference Chebyshev polynomials at step 504, and it is compared to the trajectory y(tₖ) in step 505 so as to obtain a satellite position error dr(tₖ).

In the present embodiment in particular, given a set of truth points {rₜ(tₘ), rₜ(tₘ₋₁), . . . , rₜ(t₁), rₜ(t₀)} in ECI with tₘ<tₘ₋₁< . . . <t₀ encoded in processing step 200, one then integrates y(t), Y(t) backwards from the initial condition y̅(t₀)=(rₜ(t₀), vₜ(t₀)) where vₜ(t₀) is derived from the Chebyshev polynomial. The vector p of equation (11) can be initialized to p̅=(0, 0, 0, 0, 0).

While integrating backwards, one computes in processing step 505, the differences dr(tₖ)=(rₜ(tₖ)−y(tₖ)) k=0, . . . , m and the 6×11 matrix in processing step 502

$$Ψ ( {t}_{i} ) {=}^{def} ( Φ ( {t}_{i } ) , S ( {t}_{i} ) ) as per equation \qquad ( 23 )$$

Next in processing step 506, one computes the least squares solution to the system of equations:

$${Ψ}_{ij} ( {t}_{k} ) \hat{x} ≅ d {r}_{i} ( {t}_{k} ) k = 0 , … , m ( m ≫ 10 ) , \\ i = 1 , 2 , 3 ( since position data only is being used ) \qquad ( 24 )$$

where \hat{x} is a 11 dimensional column vector and where for fixed i, Ψᵢⱼ(tₖ) is a 11 dimensional row vector.

And finally, in processing step 507, the initial elements

$$( r , v , p ) {=}^{def} ( y , p )$$

are then adjusted by
(25) y̅ᵢⁿ⁺¹= y̅ᵢⁿ+\hat{x}ᵢ i=1, 2, 3, 4, 5, 6 and p̅ᵢⁿ⁺¹= p̅ᵢⁿ+\hat{x} i=7, 8, 9, 10, 11

The initial element adjustment process of step 500 is then repeated (iterated) until a satisfactory estimate is obtained, i.e. when the computed adjustment vector 2 is less than a minimum desired value. This is accomplished by using the now partially adjusted initial element values obtained at step 507 in place of the initial elements provided at step 501 and repeating the processing steps again to obtain a new set of adjusted initial elements. By iterating on the initial conditions ( y̅ⁿ, p̅ⁿ) via (25) until the norm of \hat{x} reaches a certain minimum, one arrives at an optimum fit to the truth data. In practice n=2 iterations suffice. These iterative steps are illustrated in FIG. 1b.

It is a feature of this method that one can not only run the fitting backwards in time using historical truth data to obtain initial elements for a future prediction of a satellite orbit, but one can also run the fitting routine just described forwards in time instead to obtain a fit to a precise orbit prediction obtained by much more computationally expensive though precise models for the purposes of orbit recovery. Obviously, in such a fitting scheme, the fitting to Chebyshev models of step 200 would not be necessary. When performing such a fit, it is estimated that using the present method of determining initial elements would reduce computation time from just under 4 hours, as in the embodiment of U.S. Pat. No. 7,612,712, to under a minute. As contemplated in U.S. Pat. No. 7,612,712, the initial elements would then be sent over-the-air for later orbit recovery on a client which performs the forward integration. Note that while one could fit the first few hours of a precise orbit determination to a Chebyshev polynomial in order to obtain an approximate velocity for the initial elements, in practice it is much easier to use the method of Herrick Gibbs (Dan Boulet, Methods of Orbit Determination For The Micro Computer, p. 456). The latter requires three positions at times t₁<t₀<t₁ where t₀ is the reference time of the initial elements.

Specifically then, the method can be adapted to obtain a fit to a precise orbit prediction of a satellite in a like manner to the preceding, but instead involves obtaining the precise orbit prediction, obtaining reference satellite positions from the precise orbit prediction at a set of times {tₖ} wherein k is an integer from −1 to m, t₁<t₀<t₁< . . . <tₘ, and obtaining an initial velocity from the positions in the precise orbit prediction for time t₀. And further, the computing of the adjusted initial elements instead comprises performing numerical integration forwards in time of SSV equations to compute matrices Ψ(tₖ), performing numerical integration forwards in time of a trajectory y(tₖ) using the position, the velocity, and the at least one free parameter, and comparing the trajectory y(tₖ) to the precise orbit prediction so as to obtain a satellite position error dr(tₖ). Advantageously, the more complex calculations can be performed on a server prior to forwarding information to a mobile client.

In addition, if stack and throughput constraints allow, it is useful to adjust a scale factor for the solar pressure when using a model of the form:
(26) a_{solar pressure}=−cCᵣ r/|r|³, where c=AU² P A/m and

P≈4.5 10⁻⁶ N/m², AU is an astronomical unit, A is the approximate area of the satellite's solar panels, and m is its in-orbit mass, and Cᵣ is a scaling constant to be adjusted, and r is the sun-satellite vector.

Thus the partial of a_{solar pressure} with respect to Cᵣ is

∂aₛₚ/∂Cᵣ=−cr/|r|³

By incorporating this extra parameter in the sensitivity coefficients as an extra column in S, increasing the dimensionality in Y to 78, and adding it to the vector of parameters p in ( y̅, p̅) in equation (24), one can also adjust the solar pressure coefficient Cᵣ.

The preceding description addressed the possible detailed steps involved for one embodiment employing two integrators (y,Y). As noted before, the method described above may also be applied to an approach where only a single integrator Y is used. However, in such a case, the acceleration model a in equation (14) may be changed to that used in equation (9). Note that this complicates the computation of the partials ∂ã/∂r in equation (16).

As an optional step, one can perform a 3^{rd} backward iteration using the elements and empirical accelerations found at the end of the second iteration. While integrating backwards, one can then compare the integrator's output with respect to old truth data (potentially older than the truth data used to generate the initial elements) to generate correction models (mᵣ, mₐ, m_{c}) as in step 200. To avoid having to store radial, long-track and cross-track vectors, the preferred embodiment of this invention also stores the intermediate least squares solution matrix and vector. This has the advantage of allowing new error data added in step 200 to be optimally processed in the sense that the resulting solution (c.f. coefficients R₁, R₂, A₁, A₂, A₃, A₄, A₅, C₁, C₂) uses all new and historical data without storing and re-processing said data.

After adjustment in processing step 500, the adjusted initial elements may be passed directly to processing step 600 for forward integration or alternatively can be stored in NVRAM 9 and later read back for processing step 600. The forward integration process solves equation (9) all the while interpolating the integrator output at 900 second intervals. The machinery used for this is exactly the same Chebyshev machinery used in step 200 for the truth data. The resulting Chebyshev polynomials, and the initial elements (as well as other meta-data) can then be saved to NVRAM flash 9.

In processing step 600, the adjusted initial elements from step 500 are used in the solution of y(t) of equation (9). The output of the associated integrator may be sampled at 900 second intervals, by accruing 21 samples. Chebyshev polynomials are created in the exact same fashion as in step 200. These Chebyshev polynomials will then interpolate the entire associated integrator's output, which in a preferred embodiment covers a period of up to 7 days. The exact number of 5 hour Chebyshev blocks is determined by user defaults in processing step 300.

Processing step 700 occurs on demand. When a request for ephemeris is received, the appropriate Chebyshev polynomial is read from NVRAM flash 9 and is mapped to the native ephemeris format expected by the GNSS user receiver. It is then passed onto the GNSS receiver at output step 800. Step 700 services a request for an ephemeris model for time t₀ from the navigation software in real-time. First, one indexes into the appropriate Chebyshev polynomial for time t₀ and calculates (r(t₀), v(t₀)) via the well known recurrence relations for the derivative of a Chebyshev polynomial.

Then one must decompose the vector r(t) into its radial xᵣ(t), along xₐ(t) and cross-track x_{c}(t) components (c.f. equations (5), (6), (7)) for an embodiment). It is at this point, that one can subtract the modeled corrections calculated in step 200 (if available) from r(t):
(27)\tilde{r}(t)=r(t)−xₐ(t)*mₐ(t)−x_{c}(t)*m_{c}(t)−xᵣ(t)*mᵣ(t),
   Where mₐ(t)=A₁+A₂ dt+A₃ dt*dt+A₃ sin(2π dt)+A₄ cos(2π dt),
   m_{c}(t)=(C₁ sin(2π dt)+C₂ cos(2π dt))*dt*dt,
   mᵣ(t)=(R₁ sin(2π dt)+R₂ cos(2π dt))*dt*dt,
   and dt=(t t₀)/τ, t₀ is initial elements time-tag, and r is the satellite's period.

Thus at time t, (\tilde{r}(t),v(t)) is used rather than (r(t),v(t)) for the types of calculations below.

For NavStar-GPS, the conversion back to an ICD200 format is done using the well-known mapping (c.f. Montenbruck & Gill p. 28) from position and velocity (r,v) to the Kepler elements (A, e, I, Ω, ω, M₀). Depending on battery/processing constraints, a single pair (r(t₀),v(t₀)) can be used to generate an ephemeris, or 2 or more pairs of positions (depending on processing time requirements) can be used to create an 8 element ICD-200 ephemeris, where the 6 Kepler elements plus CRS and CRC are used (to extend the validity period).

What is less obvious is the process of constructing consistent Glonass ephemerides.

Glonass uses a well defined low accuracy acceleration model ā with 3 free-parameters lsₓ, ls_{y}, ls_{z} which account for luni-solar perturbations. First, given an input request time specified in Moscow local time (MLT), one must compute the nearest 30 minute block starting at 15 or 45 minutes past the hour (in MLT), and then use this time to compute the position and velocity in ECEF in the PZ90 datum.

By using an entirely analogous setup as for the SSV equations in processing step 500, where (y,Y) both use ā, one can perform a single iteration of the SSV equations to solve for the initial elements in equation (24) where p=(lsₓ, ls_{y}, ls_{z}) and Y is 60 dimensional. Preferably, one should use more than 3 points on the half hour are to ensure the system is over-determined.

The advantage of this method over just supplying the initial position and velocity from the Chebyshev model (in the PZ90 frame) and setting p=(0, 0, 0) is that contiguous Glonass ephemerides produced by this method will be more consistent with each other at their cross-over.

The final step in producing the predicted ephemeris is endowing it with the satellite clock bias and drift terms. Typically the bias is re-synched to the time of ephemeris.

Additionally if the radial, along-track, or cross-track corrections computed in processing step 200 are deemed big enough, then all or part can be subtracted from the position vector r, in the pair (r,v) for the mapping to Kepler elements.

Once the ephemeris is produced in a format native to the receiver, it is injected (via serial, UART, IC2, shared memory or whatever protocol is practical at output step 800) to the GNSS device whereupon it used as any broadcast ephemeris would be used to obtain a position fix using the measured pseudo ranges. Communication lags aside, the computation time involved in mapping the predicted ephemeris from its Chebyshev block to a native format is on the order of a couple of milliseconds (per satellite).

In the overall method shown in FIG. 1a, the steps may typically be formed in groups separated even by periods of several days. For instance, input step 100 and processing step 200 may be processed in one time interval. Then some time later, processing steps 300 to 600 may typically be performed in another time interval (although even here processing steps 500 and 600 may be performed at different time intervals). And finally, processing step 700 and output step 800 are typically performed when requested at yet another different time interval.

With regards to timing, FIG. 1a shows that some of its steps may be performed at disjoint time intervals I₁, I₂, and I₃. Since satellite ephemeris data typically arrives asynchronously, it is therefore likely that one will loop through the steps in interval I₁ for more than one satellite. At a later time (scheduled or otherwise), one will loop through the steps in I₂ for all satellites for which data is available. Finally, at non-deterministic times, the GNSS device will loop through some or all satellites in the steps described in I₃ depending on when the GNSS user attempts to obtain a position fix.

FIG. 1c shows a schematic of an exemplary GNSS user device 6 of the invention. FIG. 1c also illustrates the hardware associated with the various steps shown in FIG. 1a. GNSS user device 6 comprises RF circuitry 2, hardware correlators 3, which output raw measurements at 3a to CPU 4, and NVRAM 9. A satellite signal 1 is received by RF circuitry 2 which is able to tune to the GNSS frequency/frequencies. I/Q samples are provided at 2a to hardware correlators 3, and raw measurements therefrom are provided at 3a to CPU 4. The preceding hardware is associated with input step 100. CPU 4 comprises conventional embedded navigation software 4a and embedded software 4b for performing the steps of the present invention 200 to 800 inclusive. As shown, NVRAM flash memory 9 is shared by both the conventional embedded navigation software 4a and the embedded software for the method of the invention 4b and thus is common to NVRAM 9 shown in FIG. 1a. The embedded navigation software 4a and that for the present invention 4b interface through processing steps 200 to 800. On most embedded systems (e.g. SOCs which comprise device 6 in FIG. 1c, i.e. a chip with components 2, 3, 4 & 9), the navigation software and the present invention may preferably share CPU 4 and live in the same memory space, but this is not necessary. Further, it is not necessary for the navigation software to share the same NVRAM flash device 9 as that for the present invention.

It is a further feature of the invention that the aforementioned correction methods can be applied in correcting a satellite orbit prediction generally and is thus not limited to the present method for predicting the orbit of a satellite involving computing of the adjusted initial elements. Generally, the method of correcting a satellite orbit prediction of validity period [t₀, tₑ] comprise at some point tₚ during the validity period, obtaining at least one new reference satellite position, using data from the new reference satellite position, fitting an error model mₐ of the along-track error to the data from the satellite orbit prediction, for a time t in [tₚ, tₑ], evaluating the error model mₐ at t, and subtracting the evaluation from the error model mₐ at time t from the position of the satellite obtained from the satellite orbit prediction to provide a corrected prediction of satellite position. Optionally, the method can also involve correcting radial and cross-track errors in a like manner. Again advantageously, the more complex calculations can be performed on a server prior to forwarding information to a mobile client.

The following examples are illustrative of certain aspects of the invention, but should not be construed as limiting in any way.

### Examples

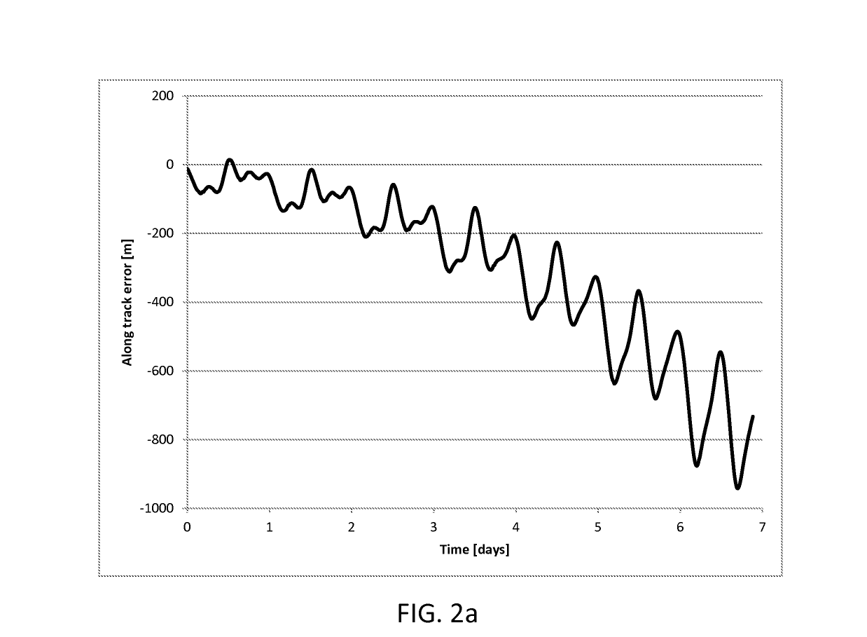

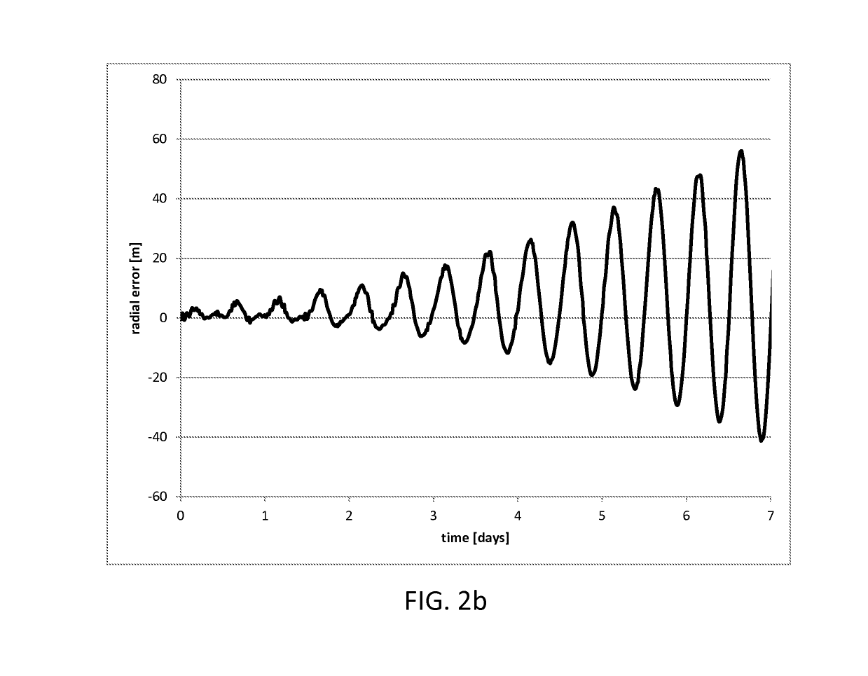

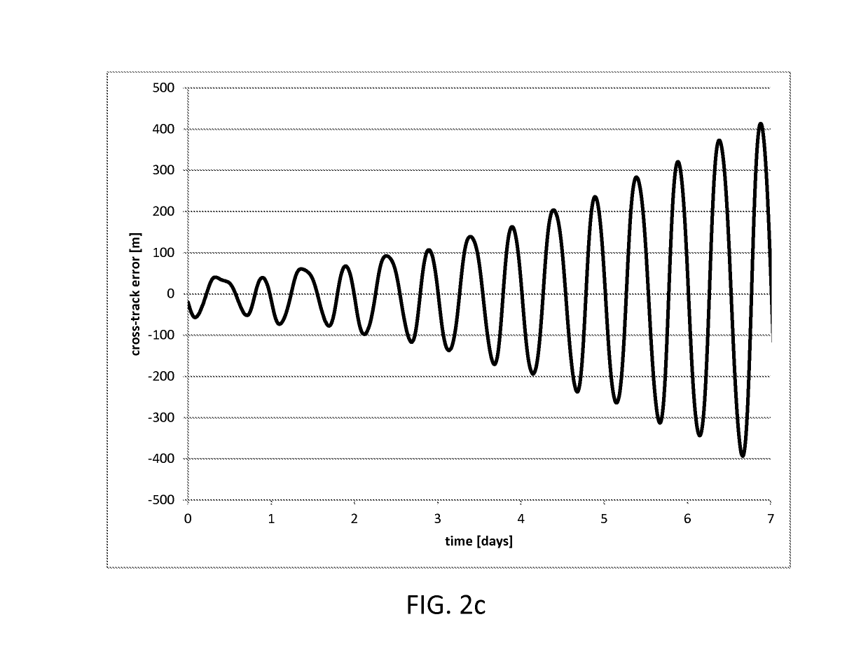

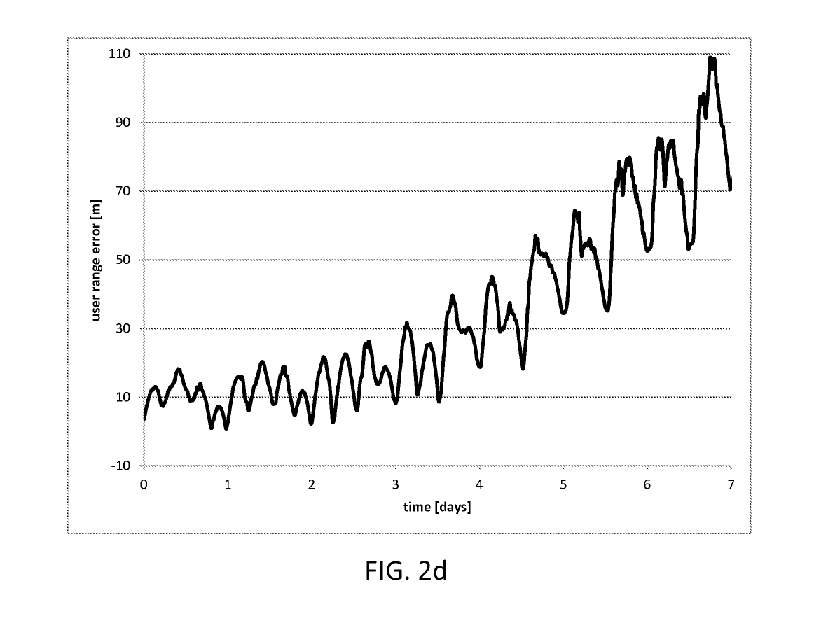

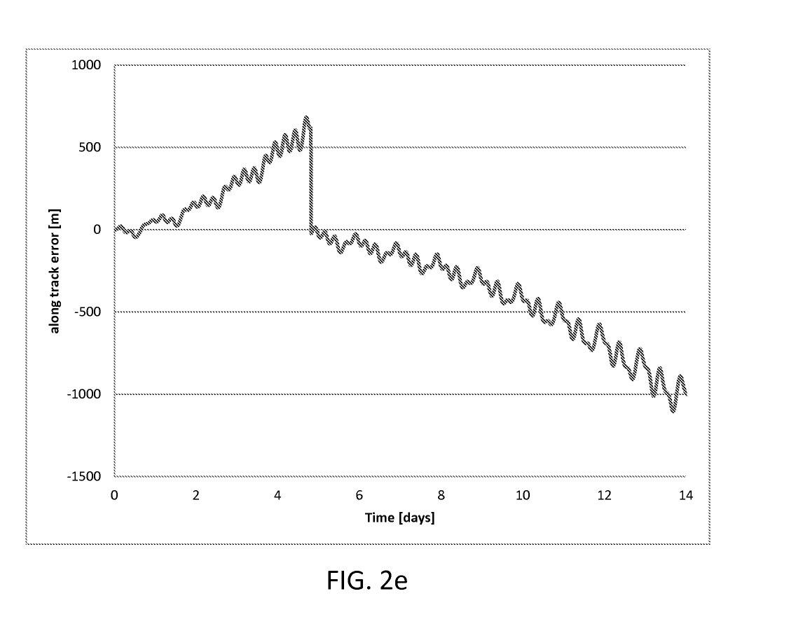

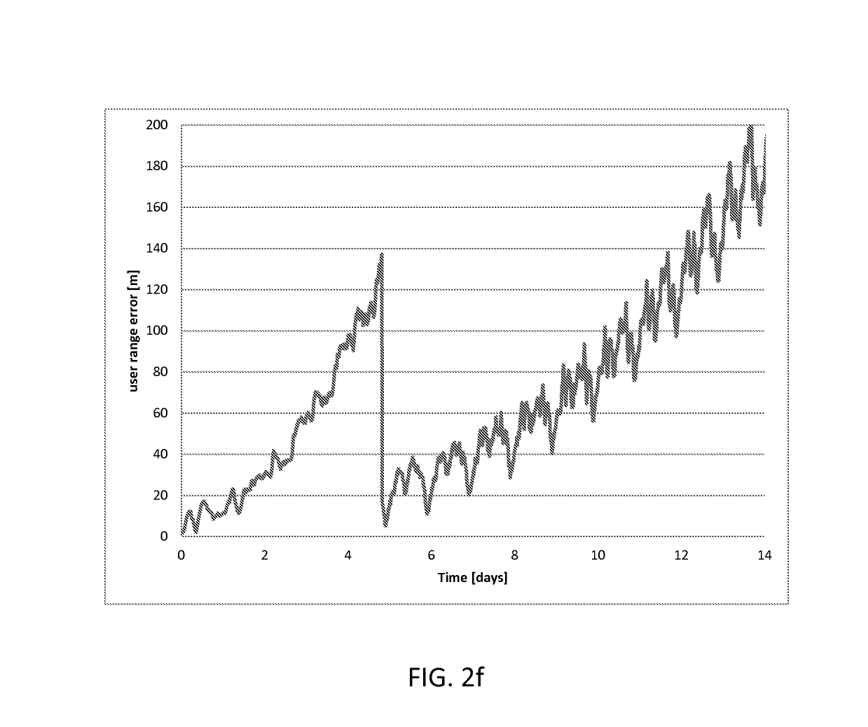

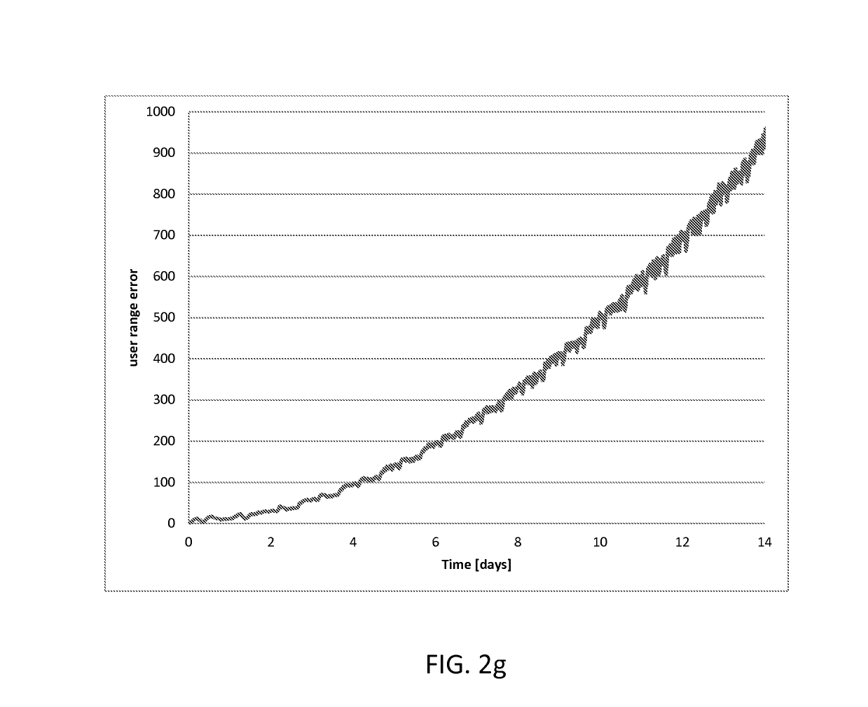

An embedded device was used to profile the prediction data for a GPS satellite using the dual integrator (y,Y) approach illustrated in FIG. 1 b, using 2 ephemerides separated by a day (24 hours) as truth data inputs. It was found to take under a minute on a 20 MHz machine to produce 7 days of prediction data for this satellite. This demonstrates that the method can be readily performed on a sub-50 MHz device. FIG. 2d shows the results of the same algorithms as above run on a PC in which the plot shown is of user range error in meters over time in days. This demonstrates that the method results in a satisfactory prediction of position. FIGS. 2a, 2b, and 2c illustrate the corresponding along-track, radial, and cross-track (respectively) errors associated with the prediction in FIG. 2d.

Since the non-radial errors only contribute roughly a quarter of their value to the line-of-sight error, these diagrams show that it is important to correct the along-track error. This is also borne out in FIG. 2d which shows a plot of the user range error in meters over time in days, again using 2 truth ephemerides spaced 24 hours apart and a dual integrator method of the invention.

On a similar run with the same configuration but going out. 14 days, a purely quadratic along-track correction (from a 5 hour truth Chebyshev polynomial) was applied on the 5^{th} day onward as shown in FIG. 2e. FIG. 2f shows the effect on the user range error, and FIG. 2g shows what the user range error would be without the along-track correction. There is about a 750 m improvement.

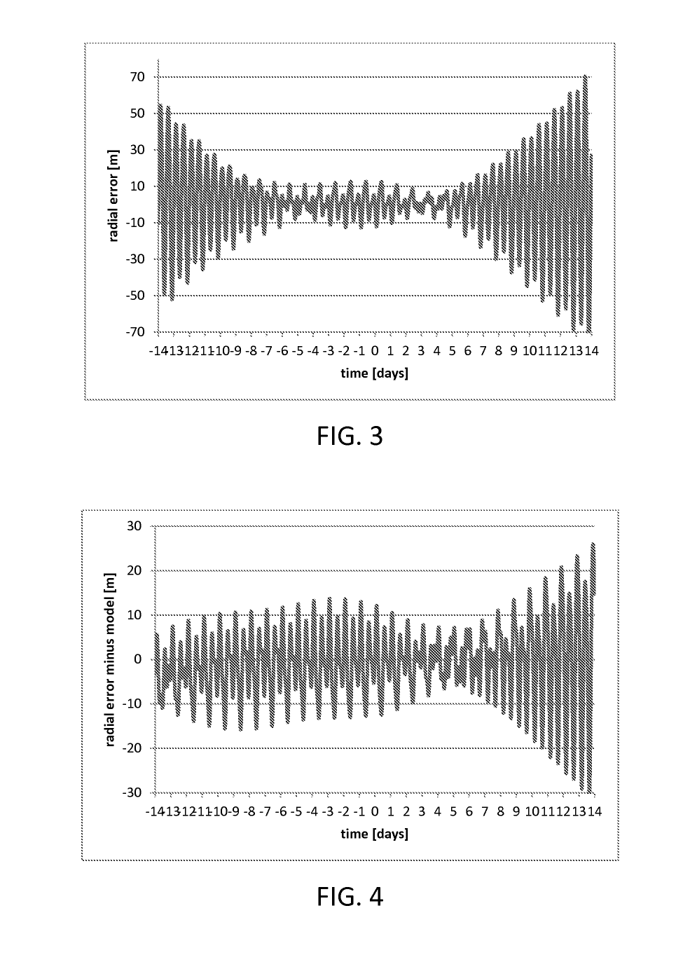

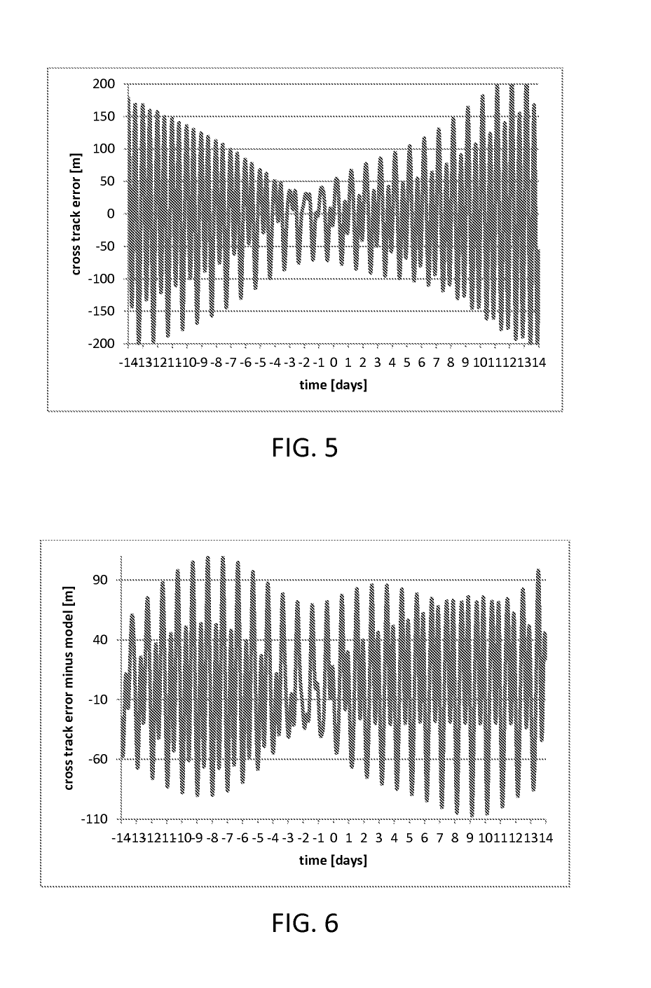

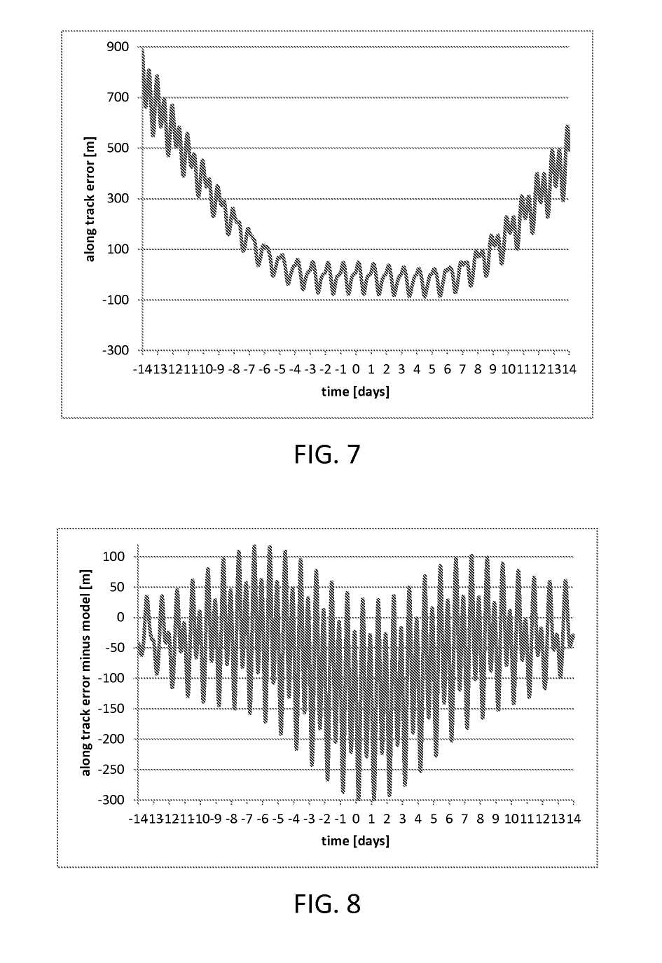

FIGS. 3 and 4 show the actual radial error and the corrected radial error after subtracting the model mᵣ respectively. The model was fit here in a 3^{rd} optional iteration of step 500 using two ephemerides 8 and 13 days old with respect to the newest ephemeris used to solve for the initial elements. Corresponding to the same setup, FIGS. 5 and 6 illustrate the actual cross-track error and the corrected cross-track error after subtracting the model m_{c} respectively. And FIGS. 7 and 8 demonstrate the actual along-track error and the corrected along track-error after subtracting the model mₐ respectively.

All of the above U.S. patents and applications, foreign patents and applications and non-patent publications referred to in this specification, are incorporated herein by reference in their entirety.

While particular embodiments, aspects, and applications of the present invention have been shown and described, it is understood by those skilled in the art, that the invention is not limited thereto. Many modifications or alterations may be made by those skilled in the art without departing from the spirit and scope of the present disclosure.

What is claimed is:

1. A method for predicting the orbit of a satellite, the satellite characterized by initial elements at initial time t₀, comprising:
obtaining reference satellite positions at a set of times {tₖ} wherein k is a positive integer from 0 to m, tₘ<tₘ₋₁< . . . <t₀;
interpolating the reference satellite positions to compute reference Chebyshev polynomials;
storing the reference Chebyshev polynomials;
updating the satellite clock bias and drift and storing the updated clock bias and drift;
computing adjusted initial elements at initial time t₀; and
computing predicted Chebyshev ephemerides using the adjusted initial elements;
wherein the computing of the adjusted initial elements comprises:
a) obtaining a set of the initial elements comprising an approximate position, velocity, and at least one free parameter at time t₀;
b) performing numerical integration backwards in time of SSV equations to compute matrices Ψ(tₖ) using the position and velocity from the set of initial elements in step a);
c) performing numerical integration backwards in time of a trajectory y(tₖ) using the position, the velocity, and the at least one free parameter from the set of initial elements in step a);
d) comparing the trajectory y(tₖ) to that obtained from the reference Chebyshev polynomials so as to obtain a satellite position error dr(tₖ);
e) computing adjustment vector z wherein 2 is the least squares solution at times {tₖ} for the equation:
Ψᵢⱼ(tₖ)\hat{x}ⱼ≅drᵢ(tₖ)
and wherein i is 1, 2, 3 representing the three position axes;
f) adding adjustment vector \hat{x} to the initial elements used in steps b) and c) thereby obtaining partially adjusted initial elements; and
g) repeating steps b) through f) using the partially adjusted initial elements instead of the initial elements from step a) until the computed adjustment vector \hat{x} is less than a minimum desired value.

2. The method of claim 1 wherein the position and velocity in step a) are obtained from the reference Chebyshev polynomials.

3. The method of claim 1 wherein the approximate at least one free parameter is a mean value.

4. The method of claim 1 wherein the set of initial elements comprises a plurality of free parameters.

5. The method of claim 4 wherein the plurality of free parameters comprise a plurality of empirical accelerations.

6. The method of claim 1 comprising performing steps b) and c) as separate numerical integrations.

7. The method of claim 1 comprising performing steps b) and c) as a single numerical integration.

8. The method of claim 1 wherein lunar, solar, and empirical accelerations are not used in step b) in the performing of the numerical integration.

9. The method of claim 1 wherein the equations of motion for the computing of matrices Ψ(tₖ) in step b) use a 72 dimensional vector.

10. The method of claim 1 wherein default values are used for the other elements in computing the matrices Ψ(tₖ) in step b).

11. The method of claim 1 additionally comprising mapping the predicted Chebyshev ephemerides into a format native to the ephemeris model for the satellite's constellation.

12. The method of claim 1 wherein the reference satellite positions are obtained from an external ephemeris model via a function call-back.

13. The method of claim 1 wherein the reference satellite positions are obtained from BCE.

14. The method of claim 1 wherein the reference satellite positions are obtained via a ground-based connection.

15. A method for obtaining a fit to a precise orbit prediction of a satellite, the satellite characterized by initial elements at initial time t₀), comprising:
obtaining the precise orbit prediction;
obtaining reference satellite positions from the precise orbit prediction at a set of times {tₖ} wherein k is an integer from −1 to m, t₁<t₀<t₁< . . . <tₘ;
obtaining an initial velocity from the positions in the precise orbit prediction;
updating the satellite clock bias and drift and storing the updated clock bias and drift;
computing adjusted initial elements at initial time to; and
computing predicted Chebyshev ephemerides using the adjusted initial elements;
wherein the computing of the adjusted initial elements comprises:
a) obtaining a set of the initial elements comprising an approximate position, velocity, and at least one free parameter at time t₀;
b) performing numerical integration forwards in time of SSV equations to compute matrices Ψ(tₖ) using the position and velocity from the set of initial elements in step a);
c) performing numerical integration forwards in time of a trajectory y(tₖ) using the position, the velocity, and the at least one free parameter from the set of initial elements in step a);
d) comparing the trajectory y(tₖ) to the precise orbit prediction so as to obtain a satellite position error dr(tₖ);
e) computing adjustment vector \hat{x} wherein \hat{x} is the least squares solution at times {tₖ} (k=0, . . . , m) for the equation:
Ψᵢⱼ(tₖ)\hat{x}ⱼ≅drᵢ(tₖ)
and wherein i is 1, 2, 3 representing the three position axes;
f) adding adjustment vector \hat{x} to the initial elements used in steps b) and c) thereby obtaining partially adjusted initial elements; and
g) repeating steps b) through f) using the partially adjusted initial elements instead of the initial elements from step a) until the computed adjustment vector \hat{x} is less than a minimum desired value.

16. The method of claim 15 comprising:
computing the adjusted initial elements on a server;
transmitting the adjusted initial elements to a mobile client by a wired or wireless connection; and
computing the predicted Chebyshev ephemerides using the adjusted initial elements on the mobile client.

17. The method of claim 1 comprising storing the predicted along-track error with respect to any recent BCE in addition to storing the reference Chebyshev polynomials so as to later estimate and subtract it.

18. The method of claim 1 wherein the satellite belongs to a GNSS system.

19. The method of claim 1 comprising:
at some point tₕ before tₘ, obtaining at least one historical reference satellite position;
using data from the historical reference satellite position, fitting an error model mₐ of the along-track error to the data from the trajectory y(tₕ);
for a time t>t₀, evaluating the error model mₐ at t; and
subtracting the evaluation from the error model mₐ at time t from the predicted position of the satellite to provide a corrected prediction of the orbit of the satellite.

20. The method of claim 19 additionally comprising:
using data from the historical reference satellite position, fitting error models mᵣ and m_{c} of the radial and cross-track errors to the data from the trajectory y(tₕ);
evaluating the error models mᵣ and m_{c} at t; and
subtracting the evaluation from the error models mₐ, mᵣ, and m_{c} at time t from the predicted position to provide a corrected prediction of the orbit of the satellite.

21. The method of claim 20 additionally comprising storing the intermediate matrices and vectors for the least squares solution of the error models mᵣ, mₐ, and m_{c}.

22. A device for predicting the orbit of a satellite wherein the predicting is performed according to the method of claim 1.

23. The device of claim 22 wherein the device is a sub-50 Mhz device.

24. The device of claim 22 comprising a subsystem for obtaining the reference satellite positions;
a CPU comprising at least one integrator for performing steps b) and c), and memory.

25. The device of claim 24 wherein the CPU comprises two integrators.

26. The device of claim 24 wherein the CPU comprises a single integrator.

27. A method of correcting a satellite orbit prediction of validity period [t₀, tₑ] comprising:
at some point tₚ, during the validity period, obtaining at least one new reference satellite position;
using data from the new reference satellite position, fitting an error model mₐ of the along-track error to the data from the satellite orbit prediction;
for a time t in [tₚ, tₑ], evaluating the error model mₐ at t; and
subtracting the evaluation from the error model mₐ at time t from the position of the satellite obtained from the satellite orbit prediction to provide a corrected prediction of satellite position.

28. The method of claim 27 additionally comprising:
using data from the new reference satellite position, fitting error models mᵣ and m_{c} of the radial and cross-track errors to the data from the satellite orbit prediction;
for the time t in [tₚ, tₑ], evaluating the error models mᵣ and m_{c} at t; and
subtracting the evaluation from the error models mₐ, mᵣ, and m_{c} at time t from the position of the satellite obtained from the satellite orbit prediction to provide a corrected prediction of satellite position.

29. The method of claim 27 wherein the along-track error model mₐ is a quadratic model.

30. The method of claim 29 wherein the along-track error model mₐ is a quadratic and sinusoidal model.

31. The method of claim 28 wherein the radial and cross-track models mᵣ and m_{c} are sinusoidal with quadratic envelopes.

32. The method of claim 27 comprising:
fitting the error model mₐ on a server;
transmitting the error model mₐ to a mobile client by a wired or wireless connection; and
evaluating the error model mₐ at t and subtracting the evaluation from the position of the satellite obtained from the satellite orbit prediction on the mobile client.

33. The method of claim 32 comprising:
fitting the error models mᵣ and m_{c} on a server;
transmitting the error models mᵣ and m_{c} to a mobile client by a wired or wireless connection; and
evaluating the error models mᵣ and m_{c} at t and subtracting the evaluation from the position of the satellite obtained from the satellite orbit prediction on the mobile client.
